(19) United States
(12) Patent Application Publication
(10) Pub. No.: US 2005/0119469 A1
(43) Pub. Date: Jun. 2, 2005

(54) Saccharide sulfation methods

(76) Inventor: Gregory A Smith, Miami, FL (US)

Correspondence Address: IVAX CORPORATION, 4400 BISCAYNE BOULEVARD, MIAMI, FL, 33137, US

(21) Appl. No.: 10/487,464

(22) PCT Filed: Aug. 30, 2002
(86) PCT No.: PCT/US02/27614

Related U.S. Application Data
(60) Provisional application No. 60/316,337, filed on Aug. 31, 2001.

(51) Int. Cl. C08B 37/08; C08B 37/10; C08B 35/02

(52) U.S. Cl. 536/20; 536/54; 536/107; 536/21

(57) ABSTRACT

The invention relates to methods for the sulfation of saccharides. In particular, the invention relates to methods for the sulfation of low molecular weight saccharides derived from glycosaminoglycans.

### BACKGROUND OF THE INVENTION

1. Field of the Invention

This invention relates to methods for the sulfation of saccharides. In particular, the invention relates to methods for the sulfation of low molecular weight oligosaccharides.

2. Background of the Invention

Sulfated polysaccharides exhibit a variety of important biological activities. For example, Guezennec et al., Carbohydrate Polymers, 37: 19 (1998), discloses that dextran sulfate has anticoagulant and antilipemic properties. Baba et al., Antimicrob. Agents Chemother., 32, 1742 (1988), discloses that sulfated polysaccharides are potent and selective inhibitors of various enveloped viruses.

Glycosaminoglycans (GAG) are polysaccharides composed of alternating hexosamine and aldouronic acid residues. Naturally occurring biologically active glycosaminoglycans include heparin, heparan sulfate, dermatan sulfate, chondroitins, chondroitin sulfates, keratin sulfate, and hyaluronic acid. Low molecular weight fragments of glycosaminoglycans and synthetic sulfated oligosaccharides also exhibit biological activity. Petitou and Choay, U.S. Pat. No. 5,013,724, disclose depolymerised heparins with anti-thrombotic, lipid-lowering, and fibrinolytic activity. Ahmed et al., U.S. Pat. No. 5,690,910, teaches that ultra-low molecular weight (<3,000 Da) heparin fractions are useful for the treatment of asthma. Conrad et al., U.S. Pat. No. 5,380,716, and Hosang et al., U.S. Pat. No. 5,447,919, teach that highly sulfated tri- to octasaccharides are active as inhibitors of smooth muscle cell proliferation.

Sulfate content plays an important role in the biological activity of these oligo-and polysaccharides. In particular, it is often desirable to achieve a higher degree of sulfation than the degree of sulfation observed in naturally occurring glycosaminoglycans. Petitou et al., U.S. Pat. No. 5,013,724, describes a process for the sulfation of glycosaminoglycans, but this process requires prior conversion of the glycosaminoglycan into an organic amine salt. There is thus a need in the art for more efficient processes for the sulfation of saccharides.

### BRIEF SUMMARY OF THE INVENTION

The invention provides methods for the sulfation of low molecular weight oligosaccharides. These methods offer advantages in yield and efficiency when compared to prior art methods.

In one aspect, the invention provides a process for the sulfation of a sodium or ammonium saccharide salt. The starting saccharide preferably comprises a heterogeneous or homogeneous collection of mono-, di-, and/or oligosaccharides in sodium or ammonium salt form. In certain preferred embodiments, more than 85% of the saccharides in the starting saccharide are composed maximally of eight sugar residues.

In some embodiments, the starting saccharide comprises a glucuronic acid or iduronic acid residue. In some embodiments, the disaccharides in the starting saccharide have no more than seven sulfation sites. In some embodiments, the disaccharides in the starting saccharide have no more than six sulfation sites.

In the process according to this aspect of the invention, the starting saccharide salt is dissolved in a dipolar aprotic solvent, preferably selected from the group consisting of pyridine, pyridine-dimethyl formamide (DMF), and pyridine-dimethylsulfoxide (DMSO), and is treated with a sulfating agent.

In a second aspect, the invention provides a process for the sulfation of a saccharide derived from a glycosaminoglycan. In the process according to this aspect of the invention, the glycosaminoglycan is first depolymerized under conditions suitable to produce a starting saccharide comprising a mixture of mono-, din, and oligosaccharides. In certain preferred embodiments, more than 85% of the saccharides in the starting saccharide are composed maximally of eight sugar residues.

In some embodiments, the starting saccharide comprises a glucuronic acid or iduronic acid residue. In some embodiments, the disaccharides in the starting saccharide have no more than seven sulfation sites. In some embodiments, the disaccharides in the starting saccharide have no more than six sulfation sites.

The starting saccharide, in sodium or ammonium salt form, is then dissolved in a dipolar aprotic solvent and treated with a sulfating agent, as described for the first aspect of the invention. In one embodiment, the dipolar aprotic solvent is selected from the group consisting of pyridine, pyridine-DMF, and pyridine-DMSO.

In a third aspect, the invention provides a process for the sulfation or a disaccharide derived from a glycosaminoglycan. In the process according to this aspect of the invention, the glycosaminoglycan is first depolymerized under conditions suitable to produce a mixture of mono-, di-, and oligosaccharides, and the saccharide mixture is separated to afford a disaccharide fraction, preferably wherein the disaccharides are in sodium or ammonium salt form.

In some embodiments, the disaccharides comprise a glucuronic acid or iduronic acid residue. In some embodiments, the disaccharides have no more than seven sulfation sites. In some embodiments, the disaccharides have no more than six sulfation sites.

The disaccharide fraction is then dissolved in a dipolar aprotic solvent and treated with a sulfating agent as described for the first and second aspects of the invention. In one embodiment, the dipolar aprotic solvent is selected from the group consisting of pyridine, pyridine-DMF, and pyridine-DMSO.

### DETAILED DESCRIPTION

This invention relates to methods for the sulfation of saccharides. In particular, the invention provides methods for the sulfation of low molecular weight oligosaccharides. More particularly, the invention provides methods for the sulfation of low molecular weight oligosaccharides derived from glycosaminoglycans.

The patent and scientific literature referred to herein establishes knowledge that is available to those with skill in the art. The issued patents, published applications, and references that are cited herein are hereby incorporated by reference to the same extent as if each was specifically and individually indicated to be incorporated by reference. In the case of inconsistencies, the present disclosure will prevail.

For purposes of the present invention, the following definitions will be used:

The term “glycosaminoglycan” or “GAG”, as used herein, includes any polysaccharide essentially composed of alternating hexosamine and aldouronic acid residues, as well as fractions, fragments, and salts thereof. Thus, “GAG” is not limited to naturally occurring GAGs.

As used herein, the term “degree of sulfation” refers to the number of sulfate groups —OSO₃ per disaccharide unit.

As used herein, the term “sulfation site” refers to a functional group that can be sulfated. Preferably, the functional group is a hydroxy or amino group. As used herein, “sulfation site” includes both free functional groups that can be sulfated and functional groups that already bear a sulfate group.

The terms “heparin” and “heparan sulfate” refer generally to any preparation isolated from a mammalian tissue in a manner conventional for the preparation of heparin as an anticoagulant, or to any preparation otherwise obtained or synthesized and corresponding to that obtained from tissue. Such preparations are composed of repeating units of D-glucosamine and either L-iduronic or D-glucuronic acids. The size and precise nature of the polymeric chains and the degree of sulfation in heparin varies from preparation to preparation, and the terms “heparin” and “heparin sulfate” are intended to cover all such preparations.

As used herein, the term “ammonium salt” refers to NH₄⁺ salts, and expressly excludes salts derived from organic amines, e.g., tetrabutylammonium salts.

As used in this specification, the singular forms “a”, “an” and “the” specifically also encompass the plural forms of the terms to which they refer, unless the content clearly dictates otherwise. For example, reference to “an oligosaccharide” includes mixtures of oligosaccharides, and reference to “a disaccharide” includes mixtures of disaccharides.

As used in this specification, whether in a transitional phrase or in the body of the claim, the terms “comprise(s)” and “comprising” are to be interpreted as having an open-ended meaning. That is, the terms are to be interpreted synonymously with the phrases “having at least” or “including at least”. When used in the context of a process, the term “comprising” means that the process includes at least the recited steps, but may include additional steps. When used in the context of a compound or composition, the term “comprising” means that the compound or composition includes at least the recited features or components, but may also include additional features or components.

In one aspect, the invention provides a process for the sulfation of a saccharide sodium or ammonium salt. The starting saccharide preferably comprises a heterogeneous or homogeneous collection of mono-, di-, and/or oligosaccharides in sodium or ammonium salt form. In the process according to this aspect of the invention, the starting saccharide salt is dissolved in a dipolar aprotic solvent, preferably selected from the group consisting of pyridine, pyridine-DMF, and pyridine-DMSO, and is treated with a sulfating agent.

In some preferred embodiments, the starting saccharide is obtained by chemical synthesis, utilizing art-recognized procedures for carbohydrate synthesis. In some other preferred embodiments, the starting saccharide is obtained by depolymerization of a polysaccharide. Methods for depolymerization of polysaccharides are known in the art, and are further described below. Preferably, the polysaccharide is a glycosaminoglycan, more preferably a naturally occurring biologically active glycosaminoglycan. Non-limiting examples of such naturally occurring biologically active glycosaminoglycans include heparin heparan sulfate, dermatan sulfate, chondroitins, chondroitin sulfates, keratin sulfate, and hyaluronic acid. In some particularly preferred embodiments, the polysaccharide or heparan sulfate.

In some embodiments, the starting saccharide comprises a glucuronic acid or iduronic acid residue. In some embodiments, the disaccharides in the starting saccharide have no more than seven sulfation sites. In some embodiments, the d have no more than six sulfation sites.

In certain preferred embodiments, more than 85%, 90%, or 95% of the saccharides in the starting saccharide are composed maximally of eight sugar residues. Preferably, less than about 25%, more preferably about 20%, still more preferably about 15% of the saccharides in the starting saccharide have more than four (4) sugar residues. In preferred embodiments, at least about 20%, preferably about 25%, more preferably about 30%, still more preferably about 35% of the saccharides in the starting saccharide are disaccharides.

The sulfation of the starting saccharide salt can be carried out using known methods for the sulfation of hydroxy groups. Examples of suitable sulfating agents include complexes of sulfur trioxide, such as, for example, SO₃.pyridine, SO₃.trimethylamine, SO₃.triethylamine, SO₃.dioxane, and SO₃.dimethyl formamide. Other examples of suitable sulfating agents include, without limitation, chlorosulfonic acid, mixtures of chlorosulfonic acid and sulfuric acid, and piperidine N-sulfate.

The sulfation reaction is preferably performed in a dipolar aprotic solvent. Pyridine enhances solubility of the saccharide sodium or ammonium salt, and is preferably included in the solvent mixture. Preferred solvents include, without limitation, pyridine, pyridine-DMF, and pyridine-DMSO.

The reaction can be performed at room temperature or at an elevated temperature, for example at 15-100° C. Preferably the reaction temperature is at least about 20° C., more preferably about 25° C., still more preferably about 30° C. Preferably, the reaction temperature does not exceed about 90° C., preferably about 80° C., still more preferably about 70° C. In some preferred embodiments, the reaction mixture is heated at about 50-60° C.

Workup of the reaction mixture and isolation of the sulfated saccharide product can be accomplished by known methods. Preferably, solvents are removed under reduced pressure, and the residue is dissolved in water, adjusted to neutral pH, and lyophilized. The crude sulfated saccharide product is preferably purified by chromatographic methods, for example, size exclusion chromatography (SEC). Elution with ammonium bicarbonate will afford the sulfated saccharide in ammonium salt form after lyophilization of the eluent. If another salt form of the product is desired, e.g., the sodium salt, it can be obtained by passing the ammonium salt through a cation exchange resin.

In a second aspect, the invention provides a process for the sulfation a saccharide derived from a glycosaminoglycan. In the process according to this aspect of the invention, the glycosaminoglycan is first depolymerized under conditions suitable to produce a starting saccharide comprising a mixture of mono, di-, and oligosaccharides. The depolymerization step can be performed using any of the procedures known in the art. Non-limiting examples of reagents suitable for effecting depolymerization of polysaccharides, including glycosaminoglycans such as heparin, include nitrous acid, periodate, and heparinase. Typically, nitrous acid is prepared in situ by acidification of solutions containing sodium nitrite. By adjusting the reaction conditions, it is possible to alter the extent of depolymerization.

Preferably, more than 85%, 90%, or 95% of the saccharides present in the reaction mixture after depolymerization are composed maximally of eight sugar residues. Preferably, less than about 25%, more preferably about 20%, still more preferably about 15% of the saccharides in the mixture have more than four (4) sugar residues. In preferred embodiments, at least about 20%, preferably about 25%, more preferably about 30%, still more preferably about 35% of the saccharides in the mixture are disaccharides.

In preferred embodiments according to the present invention, nitrous acid is employed in large excess, at a concentration from about 0.2 M to about 0.5 M. The pH of the reaction mixture is preferably maintained from about 1 to about 4, more preferably from about 1 to about 3, and most preferably from about 1.5 to about 2. A reaction temperature near ambient temperature is preferred, but somewhat lower or somewhat higher temperatures may be tolerated. For purposes of the invention, the term “ambient temperature” refers to the customary indoor temperature in the place and at the time that the reaction is carried out. Typically, ambient temperatures range from about 15° C. to about 30° C.

In some preferred embodiments, the depolymerization step further comprises treating the reaction mixture with a reducing agent. Thus, after the depolymerization reaction has proceeded to the desired extent, the reaction mixture is preferably made basic by the addition of an alkali base, preferably sodium hydroxide, and treated with a reducing agent, preferably sodium borohydride. The starting saccharide is preferably isolated by lyophilization of the neutralized reaction mixture. In a preferred embodiment, sodium hydroxide is used to adjust the pH of the reaction mixture, and the starting saccharide is, obtained in sodium salt form.

In some embodiments, the starting saccharide comprises a glucuronic acid of iduronic acid residue. In some embodiments, the disaccharides in the starting saccharide have no more than seven sulfation sites. In some embodiments, the disaccharides in the starting saccharide have no more than six sulfation sites.

The starting saccharide, in sodium or ammonium salt form is then dissolved in a dipolar aprotic solvent and treated with a sulfating agent, as described for the first aspect of the invention. Preferably, the dipolar aprotic solvent is selected from the group consisting of pyridine, pyridine-DMF, and pyridine-DMSO.

In a third aspect, the invention provides a process for the sulfation of a disaccharide derived from a glycosaminoglycan. In the process according to this aspect of the invention, the glycosaminoglycan is first depolymerized under conditions suitable to produce a mixture of mono-, di-, and oligosaccharides, and the saccharide mixture is separated to afford a disaccharide fraction. Separation is preferably accomplished by a chromatographic procedure, preferably size exclusion chromatography. Fractions preferably are eluted with ammonium bicarbonate solutions, and the fractions containing disaccharides are combined and lyophilized to obtain a disaccharide fraction, wherein the disaccharides are in ammonium salt form. The disaccharide fractions are then sulfated followed by a subsequent separation step, preferably accomplished by a chromatographic procedure, preferably size exclusion chromatography. Fractions preferably are eluted with ammonium bicarbonate solutions If desired, the salt form can be changed, for example to the sodium salt, by exposure to a cation exchange resin prior to lyophilization of the solid.

In some embodiments, the disaccharides comprise a glucuronic acid or iduronic acid residue. In some embodiments, the disaccharides have no more than seven sulfation sites. In some embodiments, the disaccharides have no more than six sulfation sites.

The disaccharide fraction is then dissolved in a dipolar aprotic solvent and treated with a sulfating agent as described for the first and second aspects of the invention. Preferably, the dipolar aprotic solvent is selected from the group consisting of pyridine, pyridine-DMF, and pyridine-DMSO. The supersulfated disaccharides thus produced are recovered and again separated. Separation is preferably accomplished by a chromatographic procedure, preferably size exclusion chromatography. Fractions preferably are eluted with ammonium bicarbonate solutions, and the fractions containing disaccharides are combined and lyophilized to obtain a disaccharide fraction, wherein the disaccharides are in ammonium salt form. If desired, the salt form can be changed, for example to the sodium salt, by exposure to a cation exchange resin.

The following examples are intended to further illustrate certain preferred embodiments of the invention, and are not intended to limit the scope of the invention.

### EXAMPLES

### Example 1

### Supersulfation of Oligosaccharides Mixture (Oligomix)

Step 1: Preparation of Oligomix

Heparin sodium USP (25 g) (Pharmacia-Upjohn, Franklin, Ohio, USA) was gradually added to a glass beaker containing purified water (125 ml) at room temperature. The mixture was stirred with a mechanical stirrer for 50 minutes until it was completely dissolved. Concentrated HCl was added dropwise to the solution to a pH of approximately 1.5. NaNO₂ (2.6 g) (J. T. Baker, Phillipsburg, N.J., USA) was added over 5 minutes to the acidified solution and the solution was stirred for 1 hour. The pH of the reaction mixture was maintained at 1.5 by addition of concentrated HCl.

A solution of sodium hydroxide was added dropwise to the above solution to obtain a pH of 10.0. NaBH₄ (0.25 g) (Aldrich Chemical Co., Milwaukee, Wis., USA) was added to the basic solution and the reaction mixture stirred overnight at room temperature. The reaction mixture was quenched by adjusting the pH to 3.0 with concentrated HCl, and the solution stirred for approximately 10 minutes. The solution pH was then raised to approximately 6.7 with a sodium hydroxide solution. Lyophilization of the neutralized solution afforded the sodium salt of the oligosaccharide mixture (oligomix) (22.5 g).

Step 2: Supersulfation of Oligomix Sodium Salt

Anhydrous DMF (10 ml) was added to a stirred suspension of heparin-derived oligomix sodium salt (5 g) and pyridine-sulfur trioxide complex [Aldrich Chemical Co., (14.05 g)] in anhydrous pyridine (50 ml) under an argon atmosphere. The reaction mixture was heated to 60° C. in an oil bath and stirred at this temperature for 18 hours.

The reaction mixture was cooled to room temperature and the solvent was removed under reduced pressure to produce a solid residue. The solid residue was dissolved in purified water, and the pH of the solution was adjusted to 6.8 (±0.1) with sodium hydroxide solution.

The neutralized solution was freeze-dried to afford a flocculent solid, which was re-dissolved in purified water (100 ml) and decolorized with activated carbon (3 g). Filtration of the decolorized solution, followed by freeze-drying of the filtrate provided the crude supersulfated material as an off-white solid.

Step 3: Separation of Supersulfated Disaccharide by Size Exclusion Chromatography (SEC)

The crude supersulfated oligomix was purified by size exclusion chromatography of the solid on a 1.5 m×90 cm column containing BioRad P4 BioGel (10 L) (BioRad Labs, Hercules, Calif., USA) and eluted with 0.2 M NH₄HCO₃. The ammonium salt of the supersulfated disaccharide (2.3 g) was obtained after lyophilization of the appropriate fractions.

The ammonium salt of the supersulfated disaccharide was exchanged for the sodium salt bypassing an aqueous solution of the ammonium salt through a column containing Amberlite IR120PLUS Cation Exchange Resin (150 g) (Sigma Chemical Co., St. Louis, Mo., USA). The filtrate from the ion exchange column was freeze-dried to afford the product as a white to off-white solid (2.3 g).

### Example 2

### Supersulfation of Disaccharide

Step 1: Preparation of Disaccharide

Oligomix sodium salt (40 g), obtained as described in Example 1, was purified by size exclusion chromatography on a 1.5 m×90 cm column containing BioRad P4 BioGel (19 L) and eluting with 0.2 M NH₄HCO₃. The disaccharide ammonium salt (10 g) was obtained after lyophilization of the appropriate fractions. The ammonium salt was either directly subjected to the supersulfation conditions, or was first converted to the sodium salt by ion exchange chromatography, as described above in Example 1, step 3.

Step 2: Supersulfation of Disaccharide Salt

Anhydrous DMF (10 ml) was added to a stirred suspension of heparin-derived disaccharide sodium salt (4 g) and pyridine-sulfur trioxide complex [Aldrich Chemical Co., (6.8 g)] in anhydrous pyridine (40 ml) under an argon atmosphere. The reaction mixture was heated to 65° C. in an oil bath and stirred at this temperature for 18 hours.

The reaction mixture was cooled to room temperature and the solvent was removed under reduced pressure to produce a solid residue. The solid residue was dissolved in purified water, and the solution pH was adjusted to 6.95 (+0.1) with sodium hydroxide solution.

The neutralized solution was freeze-dried to afford a flocculent solid, which was re-dissolved in purified water (100 ml) and decolorized with activated carbon (3 g). Filtration of the decolorized solution, followed by freeze-drying of the filtrate provided the crude supersulfated material as an off-white solid.

Step 3: Purification of the Supersulfated Disaccharide

The crude supersulfated disaccharide was purified by size exclusion chromatography of the solid on a 1.5 m×90 cm column containing BioRad P4 BioGel (10 L) and eluting with 0.2 M NH₄HCO₃. The ammonium salt of the supersulfated disaccharide (4 g) was obtained after lyophilization of the appropriate fractions.

The ammonium salt of the supersulfated disaccharide was exchanged for the sodium salt by passing an aqueous solution of the ammonium salt through a column containing Amberlite IR120PLUS Cation Exchange Resin [Sigma Chemical Co., (150 g)]. The filtrate from the ion exchange column was freeze-dried to afford the product as a white to off-white solid (3.95 g).

### Example 3

### Supersulfation of Disaccharide

Step 1: Preparation of Disaccharide Salt:

Heparin Sodium USP (25 g) (Pharmacia-Upjohn) was gradually added to a glass beaker containing purified water (125 ml) at room temperature. The mixture was stirred with a mechanical stirrer for 50 minutes until it was completely dissolved. NaNO₂ (2.6 g) (J. T. Baker) was added and the solution stirred until the salt dissolved. Concentrated HCl was then added dropwise to the solution to a pH of approximately 1.5 and the resulting acidified solution stirred for approximately 1 hour.

Step 2: Reduction of Aldehyde with NaBH₄

A solution of sodium hydroxide was added dropwise to the above solution to obtain a pH of 10.0. NaBH₄ (0.25 g) (Aldrich Chemical Co.) was added to the basic solution and the reaction mixture stirred overnight at room temperature. The reaction mixture was quenched by adjusting the pH to 3.0 with concentrated HCl and the solution stirred for approximately 10 minutes. The solution pH was then raised to approximately 6.7 with a sodium hydroxide solution. Lyophilization of the neutralized solution afforded the sodium salt of the oligosaccharide mixture (22.5 g).

Step 3: Separation of Disaccharide Fraction by SEC (Provides the NH₄⁺ Salt).

Size Exclusion Chromatography (SEC) on a BioRad BioGel resin (P6; P4 or P2) with 0.2M NH₄HCO₃ as the eluting solvent, affords the disaccharide NH₄⁺ salt after freeze-drying of the appropriate fractions. The ammonium salt may be converted to the sodium salt by cation exchange using Amberlite IR120Plus (sodium form) as the exchange resin.

Supersulfation Process (from Disaccharide Salt):

Step 4: Reaction of Disaccharide Na⁺ (or NH₄⁺) salt with Pyridine.SO₃ in anhydrous Pyridine/DMF mixed solvent system.

Anhydrous DMF (10 ml) was added to a stirred suspension of Heparin-derived disaccharide sodium (or ammonium) salt (5 g) and pyridine-sulfur trioxide complex [Aldrich Chemical Co., (14.05 g)] in anhydrous pyridine (50 ml) under an Argon atmosphere. The reaction mixture was heated to 60° C. in an oil bath and stirred at this temperature for 18 hours. The reaction mixture was cooled to room temperature and the solvent removed under reduced pressure.

Step 5: Extraction of Supersulfated Disaccharide.

The semi-solid residue obtained after removal of the reaction solvent was suspended in a 5% H₂O/MeOH solution (100 ml) and stirred for 20-30 minutes at room temperature. The suspension was filtered and the filter cake re-suspended in the aqueous MeOH solution and stirred for another 20-30 minutes at room temperature. The suspension was again filtered, the filtrates combined and concentrated under reduced pressure.

The solid residue obtained was dissolved in purified water (50 ml) and the solution pH was adjusted to 6.7 (±0.1) with sodium hydroxide solution.

Activated charcoal (10 g) was added to the neutralized solution, the suspension stirred vigorously for 20 minutes and filtered through diatomaceous earth (Celite). The decolorized solution was freeze-dried to afford the crude supersulfated material as a solid.

Step 6: SEC of Aqueous Solution of Solid Residue to Give Super-Di NH₄⁺ Salt.

Size exclusion chromatography of the solid on a 1.5 m×90 cm column containing BioRad P4 (or P2) BioGel (10 L) and eluting with 0.2 M NH₄HCO₃ provided the ammonium salt of the supersulfated disaccharide (2.3 g) after lyophilization of the appropriate fractions.

Step 7: Cation Exchange of Ammonium Salt to Sodium Salt.

The ammonium salt of the supersulfated disaccharide was exchanged for the sodium salt by passing an aqueous solution of the ammonium salt through a column containing Amberlite IR120PLUS Cation Exchange Resin [Sigma Chemical Co., (150 g)]. The filtrate from the ion exchange column may again be decolorized with activated carbon and then freeze-dried to afford the product as a white to off-white solid (2.3 g).

While the foregoing invention has been described in some detail for purposes of clarity and understanding, it will be appreciated by one skilled in the art from a reading of this disclosure that various changes in form and detail can be made without departing from the true scope of the invention.

1. A process for the sulfation of saccharides, which process comprises:
(a) obtaining a starting saccharide in sodium or ammonium salt form, wherein the starting saccharide comprises a heterogenous or homogenous collection of mono-, di-, and or oligosaccharides, more than 85% of which are composed maximally of eight sugar residues;
(b) dissolving the starting saccharide salt in a dipolar aprotic solvent selected from the group consisting of pyridine, pyridine-DMF, and pyridine-DMS), thereby forming a starting saccharide salt-solvent mixture; and
(c) treating the starting saccharide salt-solvent mixture with a sulfating agent to produce a sulfated saccharide.

2. The process of claim 1, wherein the starting saccharide salt is obtained by depolymerization of a glycosaminoglycan.

3. The process of claim 2, wherein the glycosaminoglycan is heparin or heparan sulfate,

4. The process of claim 1, wherein at least about 25% of the saccharides in the starting saccharide are disaccharides.

5. The process of claim 1, wherein at least about 15% of the saccharides in the starting saccharide have more than four sugar residues.

6. A process for the sulfation of saccharides, which process comprises:
(a) depolymerizing a glycosaminoglycan to obtain a starting saccharide in sodium or ammonium salt form, wherein the starting saccharide comprises a heterogenous or homogenous collection of mono-, di-, and or oligosaccharides, more than 95% of which are composed maximally of eight sugar residues;
(b) dissolving the starting saccharide salt in a dipolar aprotic solvent selected from the group consisting of pyridine, pyridine-DMF, and pyridine-DMS), thereby forming a starting saccharide salt-solvent mixture; and
(c) treating the starting saccharide salt-solvent mixture with a sulfating agent to produce a sulfated saccharide.

7. The process of claim 6, wherein at least about 25% of the saccharides in the starting saccharide are disaccharides.

8. The process of claim 6, wherein at least about 15% of the saccharides in the starting saccharide have more, than four sugar residues.

9. The process of claim 6, wherein the depolymerization step comprises treating the glycoseaminoglycan with nitrous acid, followed by treatment with sodium borohydride.

10. The process of claim 6, further comprising the step of separating sulfated disaccharides from the mixture of sulfated saccharides.

11. The process of claim 10, wherein the separation step is performed using size exclusion chromatography.

12. A process for the sulfation of disaccharides, which process comprises:
(a) depolymerizing a glycosaminoglycan to obtain a saccharide mixture, wherein the saccharide mixture comprises mono-, di-, and oligosaccharides;
(b) separating the saccharide mixture to obtain a disaccharide fraction, wherein the disacharides are in sodium or ammonium salt form;
(c) dissolving the disaccharide fraction in a dipolar aprotic solvent selected from the group consisting of pyridine, pyridine-DMF, and pyridine-DMS), thereby forming a disaccharide salt-solvent mixture; and
(d) treating the disaccharide salt-solvent mixture with a sulfating agent to produce a sulfated disaccharide.

13. The process of claim 12, wherein the depolymerization step comprises treating the glycosaminoglycan with nitrous acid, followed by treatment with sodium borohydride.

14. The process of claim 12 wherein the glycosaminoglycan is heparin or heparan sulfate.

15. A process for the sulfation of disaccharides, which process comprises:
(a) depolymerizing a glycosaminoglycan to obtain a saccharide mixture, wherein the saccharide mixture comprises mono-, di-, and oligosaccharides;
(b) separating the saccharide mixture to obtain a disaccharide fraction, wherein the disacharides are in sodium or ammonium salt form;
(c) dissolving the disaccharide fraction in a dipolar aprotic solvent selected from the group consisting of pyridine, pyridine-DMF, and pyridine-DMS), thereby forming a disaccharide salt-solvent mixture;
(d) treating the disaccharide salt-solvent mixture with a sulfating agent to produce a sulfated disaccharide; and
(e) separating the disaccharide salt-solvent mixture to obtain a sulfated disaccharide fraction, wherein the disacharides are in sodium or animonium salt form.

16. The process of claim 15, wherein the depolymerization step comprises treating the glycosaminoglycan with nitrous acid, followed by treatment with sodium borohydride.

17. The process of claim 16, wherein the glycosaminoglycan is selected from the group comprising heparin, heparan sulfate, dermatan sulfate, chondroitins, chondroitin sulfates, keratin sulfate, and hyaluronic acid.

18. The process of claim 16, wherein the glycosaminoglycan is heparin or heparan sulfate.

19. The process of claim 16, wherein the disaccharides of the starting sacharide have, at most seven sulfation sites.

20. The process of claim 16, wherein the disaccharides of the starting sacharide have at most six sulfation sites.
